(19) United States
(12) Patent Application Publication
(10) Pub. No.: US 2020/0174279 A1
(43) Pub. Date: Jun. 4, 2020

(54) THREE-DIMENSIONAL DISPLAY DEVICE

(71) Applicant: DENSO CORPORATION, Kariya-city (JP)

(72) Inventors: Kazuyuki ISHIHARA, Kariya-city (JP); Hiroshi ANDO, Kariya-city (JP)

(21) Appl. No.: 16/780,263

(22) Filed: Feb. 3, 2020

Related U.S. Application Data
(63) Continuation of application No. PCT/JP2018/029388, filed on Aug. 6, 2018.

(30) Foreign Application Priority Data
Aug. 9, 2017 (JP) 2017-154153

(51) Int. Cl. G02B 30/27; G02B 27/01

(52) U.S. Cl. CPC G02B 30/27; G02B 27/0101; G02B 2027/0112; G02B 2027/0118; G02B 2027/0134

(57) ABSTRACT

A three-dimensional display device includes an image display, one or more color-generating refractors, and a viewpoint refractor. The image display is configured to use color generators arranged in a longitudinal direction and a lateral direction to display parallax images, two or more of the color generators acting as a pixel element for a single pixel. The color-generating refractor is configured to, while transmitting light emitted via the color generators, diverge or converge the light at a preset angle for each of the color generators. The viewpoint refractor is configured to refract the light toward respective viewpoints while transmitting the light transmitted through the color-generating refractor.

### CROSS-REFERENCE OF RELATED APPLICATIONS

The present application is a continuation application of International Patent Application No. PCT/JP2018/029388 filed on Aug. 6, 2018, which designated the U.S. and claims the benefit of priority from Japanese Patent Application No. 2017-154153 filed on Aug. 9, 2017. The entire disclosures of all of the above applications are incorporated by herein reference.

### TECHNICAL FIELD

The present disclosure relates to a three-dimensional display device used for a head-up display.

### BACKGROUND

A three-dimensional display device is required to ensure the brightness of images and also to reduce crosstalk in which light to a certain viewpoint is mixed with light to another viewpoint.

### SUMMARY

The present disclosure provides a three-dimensional display device used for a head-up display.

A three-dimensional display device in an aspect of the present disclosure comprises an image display, one or more color-generating refractors, and a viewpoint refractor. The image display is configured to use a plurality of color generators arranged in a longitudinal direction and a lateral direction to display one set or a plurality of sets of parallax images, two or more of the color generators acting as a pixel element for a single pixel. The color-generating refractor is configured to, while transmitting light emitted via the plurality of color generators, diverge or converge the light for each of the color generators, wherein the light is diverged or converged at a preset angle. The viewpoint refractor is configured to, while transmitting the light transmitted through the color-generating refractor, refract the light toward respective viewpoints.

### BRIEF DESCRIPTION OF THE DRAWINGS

FIG. 1 is a diagram illustrating a three-dimensional display device applied to a head-up display.

FIG. 2 is a plan view illustrating a configuration of the three-dimensional display device according to a first embodiment.

FIG. 3 is a schematic diagram illustrating a relationship between an arrangement of a liquid crystal panel and an arrangement of lenses according to the first embodiment.

FIG. 4 is a side view of an image generator according to the first embodiment.

FIG. 5 is a front view of a pinhole array plate.

FIG. 6 is a plan view illustrating a relationship between size of a light source and size of an image formed.

FIG. 7 is an explanatory diagram of diffracted light.

FIG. 8 is a schematic diagram illustrating an effect of a horizontal diffusion plate.

FIG. 9 is a plan view illustrating a configuration of a three-dimensional display device according to a second embodiment.

FIG. 10 is a front view of an image generator according to the second embodiment.

FIG. 11 is a plan view of an image generator according to the second embodiment.

FIG. 12 is a side view of an image generator according to the second embodiment.

FIG. 13 is a plan view of an image generator according to a third embodiment.

FIG. 14 is a side view of an image generator according to the third embodiment.

FIG. 15 is a plan view of an image generator according to a fourth embodiment.

FIG. 16 is a side view of the image generator according to the fourth embodiment.

FIG. 17 is a plan view of an image generator according to a fifth embodiment.

FIG. 18 is a side view of the image generator according to the fifth embodiment.

FIG. 19 is a plan view of an image generator according to a sixth embodiment.

FIG. 20 is a side view of the image generator according to the sixth embodiment.

FIG. 21 is a schematic diagram illustrating a relationship between an arrangement of a liquid crystal panel and an arrangement of lenses according to another embodiment.

### DETAILED DESCRIPTION

For a three-dimensional display device used for a head-up display there is a proposed technology which uses a lenticular lens to refract light for each pixel.

A three-dimensional display device is required to ensure the brightness of images and also to reduce crosstalk in which light to a certain viewpoint is mixed with light to another viewpoint. Detailed studies by the inventors have found that the crosstalk may be reduced by shielding a part of the light emitted via each pixel and decreasing an opening ratio being a ratio of an opening; however, this may reduce the brightness of images.

It is one aspect of the present disclosure to provide a technology for suppressing crosstalk in a three-dimensional display device used for a head-up display while ensuring image brightness.

A three-dimensional display device in an aspect of the present disclosure comprises an image display, one or more color-generating refractors, and a viewpoint refractor.

The image display is configured to use a plurality of color generators arranged in a longitudinal direction and a lateral direction to display one set or a plurality of sets of parallax images, two or more of the color generators acting as a pixel element for a single pixel.

The color-generating refractor is configured to, while transmitting light emitted via the plurality of color generators, diverge or converge the light for each of the color generators, wherein the light is diverge or converged at a preset angle.

The viewpoint refractor is configured to, while transmitting the light transmitted through the color-generating refractor, refract the light toward respective viewpoints.

In this three-dimensional display device, the color-generating refractor refracts the light for each of the color generators. Thus, point images exhibiting color and brightness information of respective color generators can be formed near a focal length of the color-generating refractor, and an intermediate image of the image display with an opening ratio being reduced in a pseudo manner can be formed. Therefore, crosstalk in which light to a certain viewpoint is mixed with light to another viewpoint can be suppressed. Furthermore, although the crosstalk may be suppressed by shielding a part of the light emitted via the color generators and reducing the opening ratio, a configuration of the present disclosure can form, near the focal length of the color-generating refractor, the intermediate image of the image display with the opening ratio being reduced in a pseudo manner and thus can set a relatively high opening ratio of the color generator.

Therefore, the brightness of the images generated by the three-dimensional display device can be increased.

Note that the opening ratio refers to a ratio of an opening portion to an entire region, where the entire region is a viewpoint side region of a respective color generator, a part of the entire region is shielded and the rest of the entire region is the opening portion.

Hereinafter, embodiments of the present disclosure will be described with reference to the drawings.

### 1. First Embodiment

### 1-1. Overall Structure

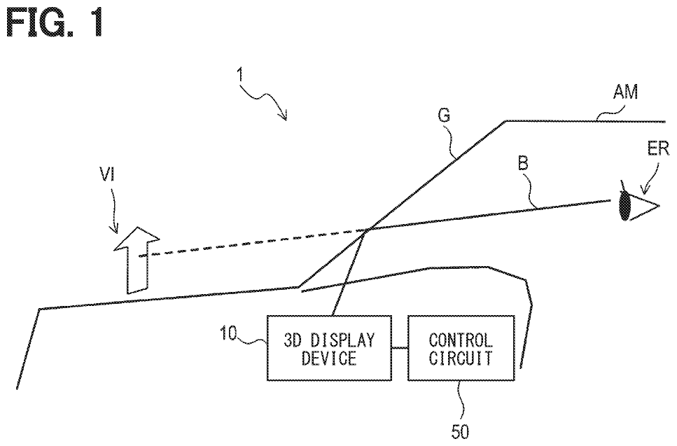

As shown in FIG. 1, a head-up display 1 according to an example of the present disclosure is mounted to a movable body such as a vehicle AM and has a function of providing a three-dimensional image. The head-up display 1 includes a three-dimensional display device 10. Further, the head-up display 1 may include a control circuit 50.

The three-dimensional display device 10 has two or more viewpoints at positions separated a certain distance from the display device and can provide parallax images according to viewpoint. The parallax image is perspective projection of a three-dimensional display target object from a set viewpoint position to a two-dimensional image.

The three-dimensional display device 10 emits an image-based light beam toward a windshield G acting as a projection target member. This light beam is reflected at the windshield G and travels toward the driver's line of sight, that is, an eye range ER. Then, in the eye range ER, a virtual image VI is formed in front of the vehicle AM and visually recognized by the driver.

A variety of information displayed as the virtual image VI includes vehicle information and foreground information. The vehicle information includes, for example, numerical information indicating a traveling state of the vehicle AM, specifically, information such as a vehicle speed, an engine speed, and a remaining fuel amount. The foreground information includes information that supplements the foreground visually recognized by the driver through the windshield G, and specifically includes information on the positions and traveling directions of pedestrians and other vehicles, information on routes to travel, and the like.

The projection target member is not limited to the windshield G, and may be a well known combiner. An optical axis B in FIG. 1 schematically illustrates, for example, a portion at the center or the like of the optical path of the light displayed by the three-dimensional display device 10.

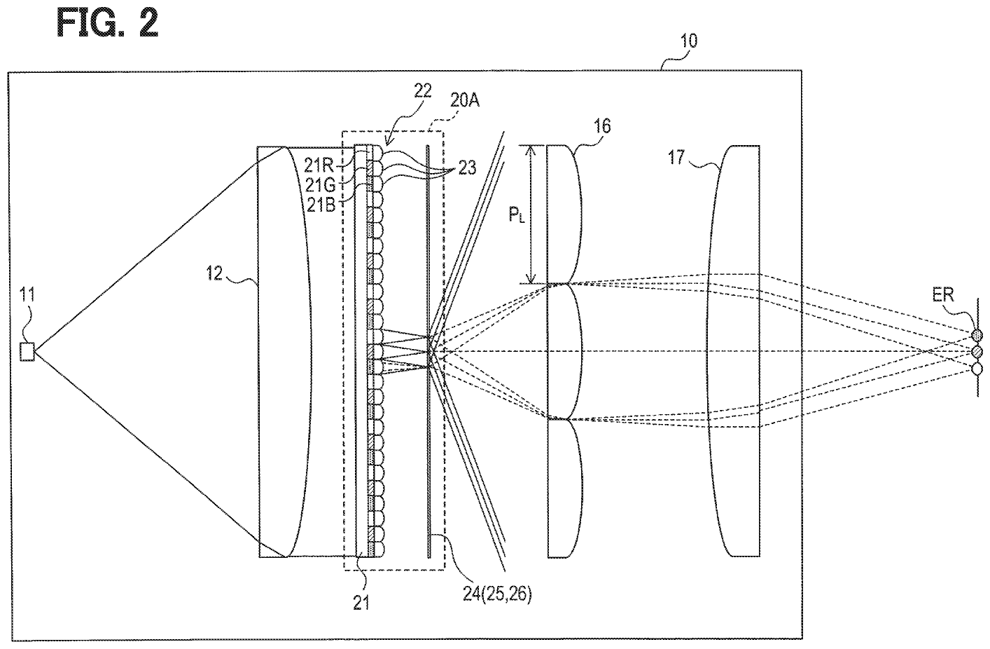

The control circuit 50 sends a control signal for controlling a light source 11 included in the three-dimensional display device 10 and a liquid crystal panel 21 shown in FIG. 2 and the like. Specifically, the control circuit 50 generates a control signal for specifying the brightness of the light source 11, the type of image to be displayed by the liquid crystal panel 21, and the like in accordance with a known sensor in the vehicle AM or a command input by a driver or the like. This control signal is sent to the three-dimensional display device 10.

As shown in FIG. 2, the three-dimensional display device 10 includes an image generator 20A, a lenticular 16 for three-dimensional vision, and a projection lens 17. The three-dimensional display device 10 may include a light source 11 and an illumination lens 12.

### 1-2. Configuration of Image Generator

The image generator 20A includes an image display 22 and a light-shielding diffusion plate 24. The image display unit 22 includes a liquid crystal panel 21 and a sub-pixel MLA 23. The MLA is an abbreviation for microlens array.

The image generator 20A of the present embodiment corresponds to a super multi-view three-dimensional display. A super multi-view system refers to a system of displaying multiple sets of parallax images at intervals equal to or smaller than the diameter of a human pupil. An ordinary multi-view system induces convergence, binocular disparity, and motion parallax as distance perception functions, whereas the super-multi-view system can further induce an adjustment function. For the super multi-view system, it is possible to use the technologies described in, for example, JP2012-18245A and the paper “Y. Takaki, Y. Urano, S. Kashiwada, H. Ando, and K. Nakamura,” Super multi-view windshield display for long-distance in image information presentation, “Opt. Express 19, 704-716 (2011)”.

Although the configuration of the present embodiment supports the super multi-view display, the present disclosure can also support other three-dimensional displays than the super multi-view display, such as ordinary multi-view display and integral imaging.

The liquid crystal panel 21, the sub-pixel MLA 23, and the light-shielding diffusion plate 24 are each formed in a plate shape.

The lenticular 16 for three-dimensional vision and the projection lens 17 are configured to, while transmitting the light emitted from the image generator 20A, refract the light toward respective viewpoints. The lenticular 16 for three-dimensional vision is configured as a well-known lenticular lens, and the projection lens 17 is configured as a well-known convex or concave lens. The curvatures and the refractive indexes of these lenses are set so that the images generated by the three-dimensional display device 10 are favorably formed in the eye range ER.

In the present embodiment, the lenticular 16 for three-dimensional vision and the projection lens 17 are configured to have different functions which are a function of dividing into viewpoints and a function of forming the viewpoints in the eye range ER; however, the functions may be integrated by changing pitch of the lenticular 16 for three-dimensional vision.

For the projection lens 17, a Fresnel lens or a diffractive optical element may be used to reduce the thickness. It may be more preferable to use an optical element having a free-curved surface shape for correcting aberration generated by the shape of the windshield, or a diffractive optical element having phase information corresponding to the free-curved surface shape.

As shown in FIG. 2, the light source 11 emits light providing a backlight of the liquid crystal panel 21 in response to a control signal from the control circuit 50, and supplies the light to the liquid crystal panel 21 via the illumination lens 12. The illumination lens 12 is configured as a convex lens that refracts the light emitted by the light source 11 so as to produce parallel light, where such a convex lens is well-known. As the illumination lens 12, a Fresnel lens or a diffractive optical element may be used for thickness reduction. As the light source 11, any lighting device such as an LED or a laser device can be used.

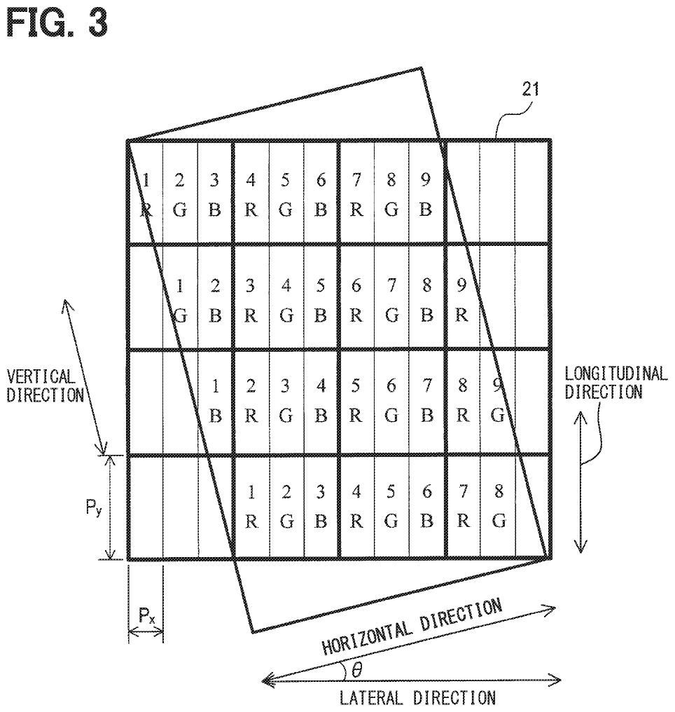

As shown in FIG. 2 and FIG. 3, the liquid crystal panel 21 includes a plurality of color generators 21R, 21G, 21B arranged in a longitudinal direction and in a lateral direction, and two or more of the color generators 21R, 21G, 21B act as a pixel element of a single pixel. The liquid crystal panel 21 is configured to control the amount of light transmitted through each of the color generators 21R, 21G, 21B in accordance with a control signal from the control circuit 50, so that multiple sets of parallax images are displayed.

The liquid crystal panel 21 is configured to transmit the light from the light source 11. The arrangement of the color generators 21R, 21G, 21B of different colors in the longitudinal direction and the lateral direction causes the plurality of color generators 21R, 21G, 21B to constitute pixel elements.

Here, the longitudinal direction is, as shown in FIG. 3, a direction corresponding to the vertical direction, but the longitudinal direction is not a direction matching the vertical direction, and the longitudinal direction is angled at a preset slight angle with respect to the vertical direction. The lateral direction is a direction perpendicular to the longitudinal direction, and is angled at the preset slight angle with respect to the horizontal direction.

In the example shown in FIG. 3, the color generators 21R, 21G, 21B in which the same numbers are depicted among the color generators 21R, 21G, 21B correspond to the same parallax image. That is, the three color generators 21R, 21G, 21B of R, G, and B arranged in the vertical direction form a single pixel.

In this configuration, since the number of parallax images generable is the number shown in FIG. 3, it is possible to increase the resolution in the horizontal direction as compared with a typical liquid crystal panel in which the longitudinal direction and the vertical direction match with each other. For example, when generating a large number of parallax images, it is possible to easily ensure the resolution in the horizontal direction.

In addition, the liquid crystal panel 21 is configured such that a portion of an entire region, the entire region being a region of a respective color generator 21R, 21G, 21B facing toward the lenticular 16 for three-dimensional vision, is shielded, and the rest portion of the respective color generator is an opening portion. The ratio of the opening portion to the entire region is defined as the opening ratio. This opening ratio is appropriately set so that the crosstalk hardly occurs.

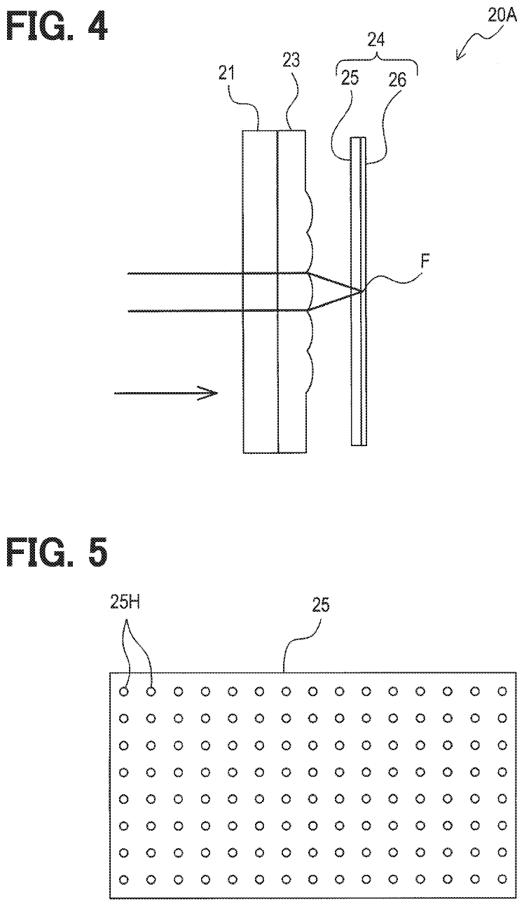

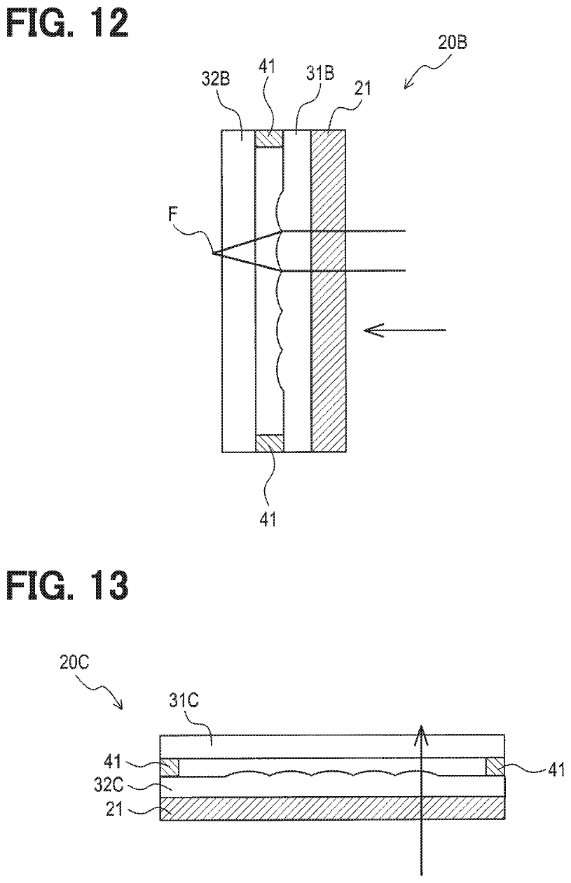

The light-shielding diffusion plate 24 includes a pinhole array plate 25 and a horizontal diffusion plate 26, as shown in FIG. 4. The pinhole array plate 25 and the horizontal diffusion plate 26 are each formed in a plate shape. The sub-pixel MLA 23 and the horizontal diffusion plate 26, while transmitting the light emitted via the plurality of color generators 21R, 21G, 21B, diverge or converge the light for each of the color generators 21R, 21G, 21B, wherein the light is diverged or converged at a preset angle. The arrows shown in FIGS. 4, 8, and 11 to 20 represent the traveling directions of the light emitted from the light source 11.

The sub-pixel MLA 23 is configured as a microlens array in which a large number of microlenses each for refracting light of a corresponding respective color generator 21R, 21G, 21B are arranged in rows and columns. A respective microlens is configured as a convex lens that converges light with respect to the vertical and horizontal directions. The microlenses have the same refractive index in the vertical and horizontal directions. The microlens may be provided by an aspherical lens, a diffractive optical element, or a holographic optical element. The horizontal diffusion plate 26 has a function of refracting the light transmitted through the sub-pixel MLA 23, so as to diffuse the light only in the horizontal direction. The horizontal diffusion plate 26 used may be, for example, a holographic element, a lenticular lens, or the like.

As shown in FIG. 4 and FIG. 5, the pinhole array plate 25 is disposed on a side of the sub-pixel MLA 23, the side facing toward the focal point position F of the sub-pixel MLA 23. The pinhole array plate 2 has a number of holes 25H for the light converged by the sub-pixel MLA 23 to pass through

The large number of holes 25H are formed corresponding to respective microlenses constituting the sub-pixel MLA 23, and are set to have such sizes that most of the light other than the light converged by the sub-pixel MLA 23 is shielded. Note that in order to suppress the crosstalk, it is preferable that the image formed by the sub-pixel MLA 23 is smaller than the size of the sub-pixel, that is, the size of an each individual color generator 21R, 21G, 21B.

This may be achieved when the following relations is met:

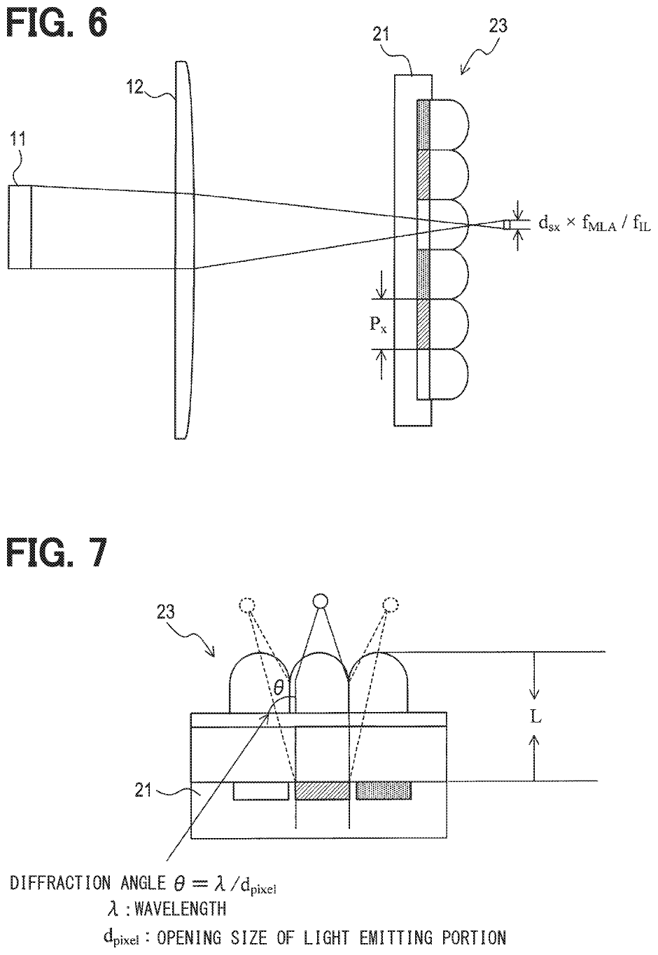

dₛₓ×f_{MLA}/f_{IL}<pₓ, AND, d_{sy}×f_{MLA}/f_{IL}<p_{y}

where, as shown in FIG. 6: x denotes the lateral direction of the color generator 21R, 21G, 21B; y denotes the longitudinal direction; pₓ and p_{y} denote pitches being intervals at which the color generators 21R, 21G, 21B are arranged; dₛₓ and d_{sy} denote the size of the light source in the lateral direction and in the longitudinal direction; f_{IL} denotes the focal length of the illumination lens 12; and f_{MLA} denotes the focal length of the sub-pixel MLA 23.

It may be more preferable to meet the following relation:

dₛₓ×f_{MLA}/f_{IL}×cos θ+d_{sy}×f_{MLA}/f_{IL}×sin θ<P_{L}/N,

where: P_{L} denotes the pitch of the lenticular lens 16 for three-dimensional vision; θ denotes the angle of the lenticular lens, and N denotes the number of viewpoints set for the super multi-view display. Note that the angle θ of the lenticular lens is the angle difference between the lateral direction and the horizontal direction shown in FIG. 3. By meeting the above expression, it is possible to reduce the crosstalk because the length of the image formed by the sub-pixel MLA 23 projected in the pitch direction of the lenticular lens 16 for three-dimensional vision is smaller than the pitch of the lenticular lens 16 divided by the number of viewpoints, that is, the projection length assigned to an each respective viewpoint.

It is known that light diffraction easily occurs at the openings of the liquid crystal panel 21. Specifically, even if parallel light is incident on the liquid crystal panel 21, divergent light is easily generated due to the diffraction. This tendency becomes more significant as the distance L between the liquid crystal panel 21 and the sub-pixel MLA 23 increases, as shown in FIG. 7. In view of this, in the present embodiment, the liquid crystal panel 21 and the sub-pixel MLA 23 are arranged in contact with each other. In addition to this configuration, the pinhole array plate 25 is arranged to suppress unnecessary light.

### 1-3. Technical Effect

The first embodiment described in detail above provides the following technical effects.

(1a) The head-up display 1 of the present disclosure includes the liquid crystal panel 21, the sub-pixel MLA 23, the horizontal diffusion plate 26, the lenticular 16 for three-dimensional vision, and the projection lens 17.

The liquid crystal panel 21 is configured to use the plurality of color generators 21R, 21G, 21B arranged in the longitudinal direction and the lateral direction to display one set or multiple sets of parallax images, wherein two or more of the color generators 21R, 21G, 21B act as a pixel element for a single pixel.

The sub-pixel MLA 23 and the horizontal diffusion plate 26 are configured to, while transmitting the light emitted via the plurality of color generators 21R, 21G, 21B, refract the light for each of the color generators 21R, 21G, 21B, wherein the light is refracted in a preset direction.

The lenticular 16 for three-dimensional vision and the projection lens 17 are configured to, while transmitting the light transmitted through the sub-pixel MLA 23 and the horizontal diffusion plate 26, refract the light toward respective viewpoints.

In such a head-up display 1, because of the horizontal diffusion plate 26 and the sub-pixel MLA 23 for refracting the light for each of the color generators 21R, 21G, 21B, it is possible to form, near the focal points of the sub-pixel MLA 23, a group of point images exhibiting information on the respective color generators 21R, 21G, 21B. In the present embodiment, since the liquid crystal panel 21 is illuminated with substantially-parallel light and thereby the size of the point image is sufficiently reduced, the group of point images can be regarded as the liquid crystal panel 21 having a reduced opening ratio. Even if the opening ratio of the liquid crystal panel 21 is increased, the opening ratio of the group of point images does not increase, so that the crosstalk can be reduced while increasing the brightness of the images. Therefore, it is possible to increase the brightness of the images generated by the head-up display 1.

(1b) In the head-up display 1, the sub-pixel MLA 23 is configured to refract the light in at least one of the vertical direction or the horizontal direction, and the horizontal diffuser 26 is configured to refract the light only in the horizontal direction.

In this head-up display 1, since the horizontal diffusion plate 26 refracts the light only in the horizontal direction, the width of the visual field, that is, the length of the eye range in the horizontal direction can be easily adjusted.

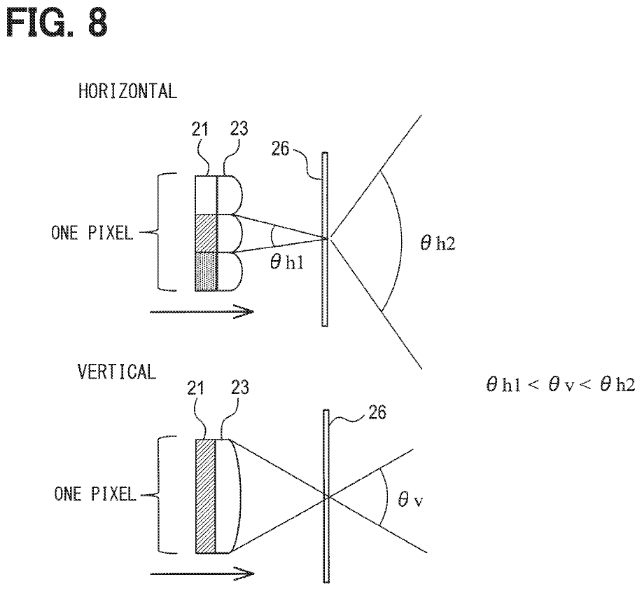

More specifically, as shown in FIG. 8, the color generators 21R, 21G, 21B are longitudinally long. Thus, in the absence of the horizontal diffusion plate 26, a longitudinally long eye range ER may be provided. Specifically, a relation θh1<θv may be realized. However, the horizontal diffusion plate 26 which diffuses the light in the horizontal direction can increase the horizontal angle of the eye range ER to θh2, resulting in the horizontally long eye range ER. That is, it is possible to realize a relation θv<θh2.

(1c) In the head-up display 1 described above, the sub-pixel MLA 23 is configured as a microlens array in which microlenses each for refracting the light of a corresponding respective color generator 21R, 21G, 21B are arrayed. The horizontal diffusion plate 26 is configured to cause the light passing through the sub-pixel MLA 23 to diffuse only in the horizontal direction.

In this head-up display 1, it is possible to use members having a substantially flat appearance to construct the head-up display 1 and it is possible to facilitate assembling the head-up display 1, as compared with a configuration provided with a plurality of lenticular lenses. More specifically, when the image generator 20A includes a plurality of lenticular lenses, it is necessary to adjust the positions and angles of the liquid crystal panel and the plurality of lenticular lenses. By contrast, in the case of the configuration of the present embodiment including the sub-pixel MLA 23 and the horizontal diffusion plate 25, it is necessary to perform only mutual position and angle adjustment for the liquid crystal panel 21 and the sub-pixel MLA 23 and it is necessary perform only angle adjustment for the horizontal diffusion plate. Accordingly, assembling is facilitated.

(1d) The head-up display 1 further includes the pinhole array plate 25. The pinhole array plate 25 is disposed on a side of the sub-pixel MLA 23, the side facing toward the focal point position F of the sub-pixel MLA 23. The pinhole array plate 25 has a number of holes 25H for the light converged by the subpixel MLA 23 to pass through.

In this head-up display 1, since the pinhole array plate 25 shields scattered light and the like other than the light converged by the sub-pixel MLA 23, the crosstalk can be further suppressed. The pinhole array plate 25 disclosed in the present embodiment is applicable to the configurations of the below described embodiments.

(1e) The head-up display 1 further includes the light source 11 and the illumination lens 12 configured to supply parallel light to the plurality of color generators 21R, 21G, 21B.

In this head-up display 1, divergent light due to diffraction at the image generator 20A is reducible.

### 2. Second Embodiment

### 2-1. Difference from the First Embodiment

Because a basic configuration of the second embodiment is the same as that of the first embodiment, differences will be described below. The same references as those in the first embodiment are used to refer to the same configurations and the preceding description.

The head-up display 1 of the first embodiment described above includes the image generator 20A having the sub-pixel MLA 23 and the horizontal diffusion plate 26. The second embodiment differs from the first embodiment in that a head-up display 2 of the second embodiment includes an image generator 20B including a pixel lenticular 31B and a sub-pixel lenticular 32B in place of the image generator 20A.

### 2-2. Configuration

In the head-up display 2 of the second embodiment, the three-dimensional display device 10 includes the image generator 20B as shown in FIG. 9. The image generator 20B includes a pixel lenticular 31B and a sub-pixel lenticular 32B in addition to the liquid crystal panel 21 described above.

The pixel lenticular 31B and the sub-pixel lenticular 32B are disposed in a stack manner on a particular side of the liquid crystal panel 21, the particular side facing toward the lenticular 16 for three-dimensional vision and the projection lens 17. In particular, the liquid crystal panel 21, the pixel lenticular 31B, and the sub-pixel lenticular 32B are stacked in this order in the image generator 20B.

Each of the pixel lenticular 31B and the sub-pixel lenticular 32B is convex lenses, and is configured as a well-known lenticular lens. The lenticular lens is configured by arranging semi-cylindrical lenses at a predetermined pitch, includes a lens portion having a predetermined radius of curvature and a flat portion having a substantially flat shape on the opposite side from the lens portion. The lenticular lens is a transparent structure having a predetermined thickness. The lenticular lens is made of, for example, glass or resin.

The pixel lenticular 31B is configured such that the semi-cylindrical lenses each having a width matching the arrangement pitch of the color generators 21R, 21G, 21B in the longitudinal direction are arranged in the vertical direction. The sub-pixel lenticular 32B is configured such that the semi-cylindrical lenses each having a width matching the arrangement pitch of the color generators 21R, 21G, 21B in the lateral direction are arranged in the horizontal direction. The sub-pixel lenticular 32B refracts the light for each of the color generators 21R, 21G, 21B.

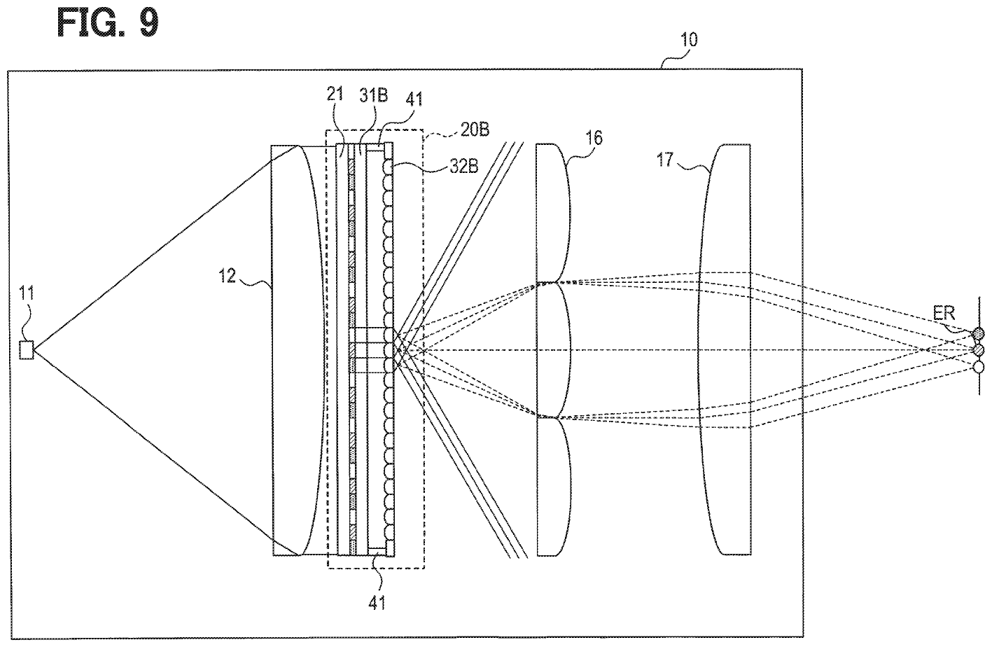

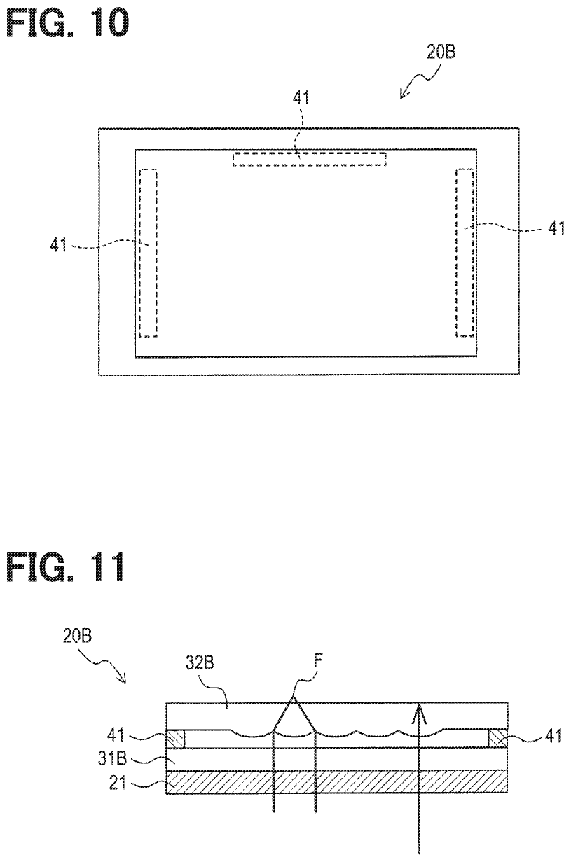

The three-dimensional display device 10 includes a spacer 41 between the pixel lenticular 31B and the sub-pixel lenticular 32B, as shown in FIGS. 10, 11, and 12. The spacer 41 includes prismatic members having the same thickness arranged at an upper end, a right end, and a left end of the pixel lenticular 31B and the sub-pixel lenticular 32B. By the spacer 41, the pixel lenticular 31B and the sub-pixel lenticular are held to have a constant distance therebetween.

The focal point positions F by the pixel lenticular 31B and the sub-pixel lenticular 32B thus held, that is, the image forming positions, are located on the same plane perpendicular to the optical axis of the pixel lenticular 31B and the sub-pixel lenticular 32B.

The focal point positions F in the present embodiment are located on a particular side of the subpixel lenticular 32B, the particular side facing toward the lenticular 16 for three-dimensional vision. Thus, when the pinhole array plate 25 shown in the first embodiment is arranged, the pinhole array plate 25 may be arranged between the subpixel lenticular 32B and the lenticular 16 for three-dimensional vision.

In order to suppress the crosstalk, it may be preferable that the image formed by the sub-pixel lenticular 32B is smaller than the size of the sub-pixel, that is, each individual color generator 21R, 21G, 21B as in the first embodiment.

In the second embodiment, it is preferable to satisfy the following relation:

dₛₓ×fₗₑₙₜᵢₓ/f_{IL}<pₓ AND d_{sy}×f_{lentiy}/f_{IL}<p_{y},

where f_{lentiy} denotes the focal length of the pixel lenticular 31B and fₗₑₙₜᵢₓ denotes that of the sub-pixel lenticular 32B.

It may be also preferable to satisfy the following relation:

dₛₓ×fₗₑₙₜᵢₓ/f_{IL}×cos θ+d_{sy}×f_{lentiy}/f_{IL}×sin θ<P_{L}/N.

This configuration can reduce the crosstalk as described above.

### 2-3. Technical Effect

The second embodiment specifically described in the above provides the technical effects of the first embodiment and further provides the below technical effects.

(2a) In the head-up display 2 described above, the plurality of color generators 21R, 21G, 21B form the pixel elements such that the color generators 21R, 21G, 21B of different colors are arranged in the lateral direction. Additionally, the pixel lenticular 31B and the sub-pixel lenticular 32B are provided.

The pixel lenticular 31B is configured such that the semi-cylindrical lenses each having a width matching an arrangement pitch of the color generators 21R, 21G, 21B in the longitudinal direction are arranged in the vertical direction. The sub-pixel lenticular 32B is configured such that semi-cylindrical lenses each having a width matching an arrangement pitch of the color generators 21R, 21G, 21B in the lateral direction are arranged in the horizontal direction.

In this head-up display 2, the light is refracted in the vertical direction and the horizontal direction by using a plurality of lenticular lenses that refract light in directions perpendicular to each other, and therefore, it is possible to diffuse the light in a favorable manner.

(2b) In the head-up display 2 described above, the pixel lenticular 31B and the sub-pixel lenticular 32B are arranged on a stack manner on a particle side of the liquid crystal panel 21, the particular side facing toward the lenticular 16 for three-dimensional vision and the projection lens 17.

In this head-up display 2, it is possible to freely adjust the interval between the pixel lenticular 31B and the sub-pixel lenticular 32B, the adjustment of the position of the image converged by the pixel lenticular 31B and the sub-pixel lenticular 32B in the optical axis direction can be easily adjusted.

(2c) In the head-up display 2 described above, the focal point positions F provided by the pixel lenticular 31B and the sub-pixel lenticular 32B are located on the same plane perpendicular to the optical axis of the pixel lenticular 31B and the sub-pixel lenticular 32B.

In this head-up display 2, image blurring can be suppressed in a configuration using the plurality of lenticulars 31B and 32B.

### 3. Third Embodiment

### 3-1. Differences from Second Embodiment

The head-up display 2 of the above-described second embodiment includes the image generator 20B provided with the pixel lenticular 31B and the sub-pixel lenticular 32B, each of which is convex lenses. The third embodiment is different from the second embodiment in that the head-up display 3 of the third embodiment includes an image generator 20C provided with a pixel lenticular 31C having concave lenses.

### 3-2. Configuration

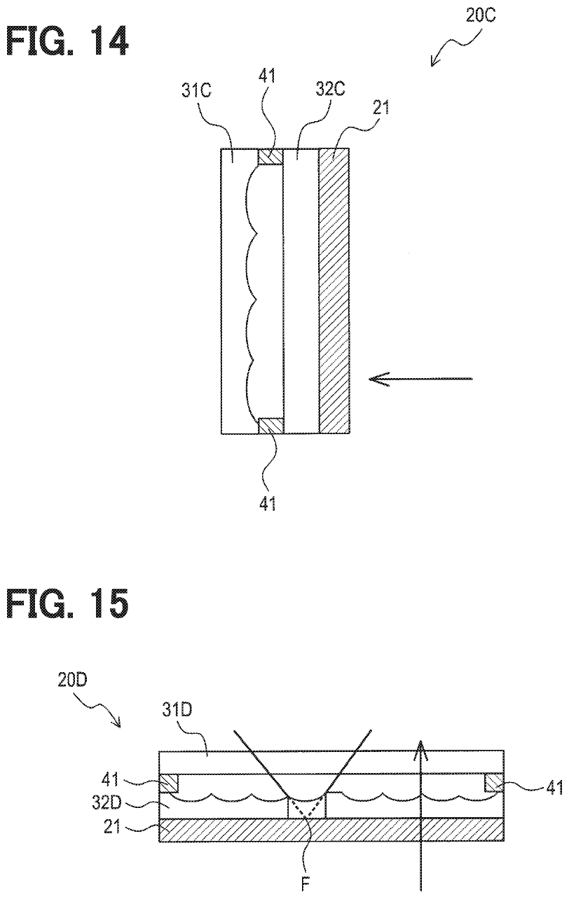

In the head-up display 3 of the third embodiment, the three-dimensional display device 10 includes the image generator 20C as shown in FIGS. 13 and 14. The image generator 20C includes a pixel lenticular 31C and a sub-pixel lenticular 32C in addition to the liquid crystal panel 21 described above.

The pixel lenticular 31C and the sub-pixel lenticular 32C are arranged in a stack manner on a particular surface side of the liquid crystal panel 21, the particular surface facing toward the lenticular 16 for three-dimensional vision and the projection lens 17. In particular, the liquid crystal panel 21, the sub-pixel lenticular 32C, and the pixel lenticular 31C are stacked in this order in the image generator 20C.

The pixel lenticular 31C is concave lenses and the sub-pixel lenticular 32C is convex lenses, and the pixel lenticular 31C and the sub-pixel lenticular 32C are configured as lenticular lenses, the lenticular lenses being well-known. The focal point positions F by the pixel lenticular 31C and the sub-pixel lenticular 32C thus held are set to be between the pixel lenticular 31C and the sub-pixel lenticular 32C.

The focal point positions F are located on the same plane perpendicular to the optical axis of the pixel lenticular 31C and the sub-pixel lenticular 32C.

### 3-3. Technical Effect

The third embodiment specifically described in the above provides the technical effect (1a) of the first embodiment described above, and further provides the following technical effects.

(3a) The liquid crystal panel 21, the sub-pixel lenticular 32C having convex lenses, and the pixel lenticular 31C having concave lenses are stacked in this order in the head-up display 3.

In this head-up display 3, the distance between the liquid crystal panel 21 and the sub-pixel lenticular 32C can be reduced in a configuration using a plurality of lenticular lenses, and thus, it is possible to suppress generation of the light diffraction at the opening of the liquid crystal panel 21.

### 4. Fourth Embodiment

### 4-1. Difference from the Above Embodiment

The head-up displays 2 and 3 of the second and third embodiments described above include the image generators 20B and 20C each having at least one lenticular lens that is convex lenses. The fourth embodiment is different from the above-described embodiments in that a head-up display 4 of the fourth embodiment includes an image generator 20D that includes a plurality of lenticular lenses each being concave lenses.

### 4-2. Configuration

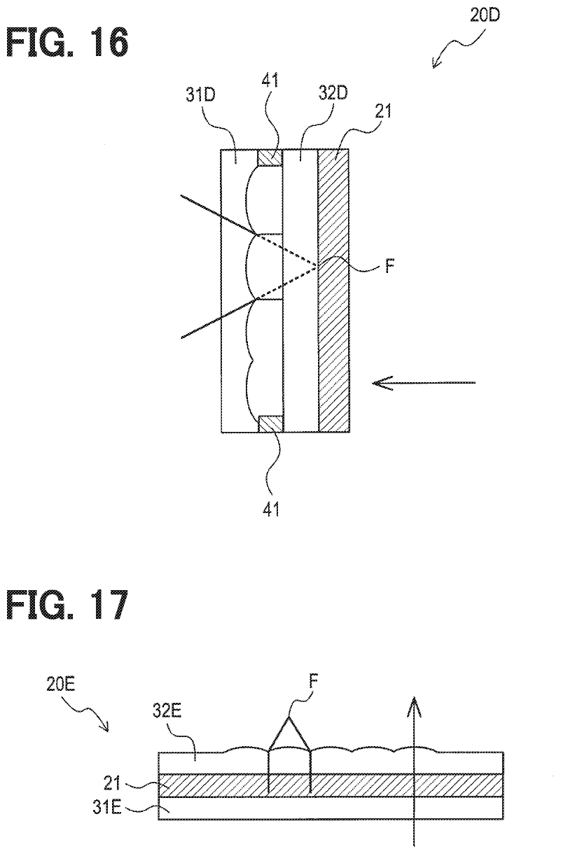

In the head-up display 4 of the fourth embodiment, the three-dimensional display device 10 includes an image generator 20D as shown in FIGS. 15 and 16. The image generator 20D includes a pixel lenticular 31D and a sub-pixel lenticular 32D in addition to the liquid crystal panel 21 described above.

The pixel lenticular 31D and the sub-pixel lenticular 32D are each concave lenses and are configured as lenticular lenses. The focal point positions F of the pixel lenticular 31D and the sub-pixel lenticular 32D held are set to be on the surface of the liquid crystal panel 21, that is, on one surface of the liquid crystal panel 21, the one surface facing toward the lenticular 16 for three-dimensional vision.

### 4-3. Technical Effect

The fourth embodiment specifically described in the above provides the technical effect (1a) of the above-described first embodiment and further provides the following technical effects.

(4a) The head-up display 4 of the fourth embodiment is configured such that the focal point positions F by the pixel lenticular 31D and the sub-pixel lenticular 32D are on the surface of the liquid crystal panel 21.

In this head-up display 3 using a plurality of lenticular lenses, the focal point positions F of the lenticular lenses are set on the surface of the liquid crystal panel 21.

### 5. Fifth Embodiment

### 5-1. Difference from the Above Embodiment

In the head-up displays 2, 3, and 4 of the second, third, and fourth embodiments described above, the image generators 20B, 20C, and 20D are configured such that a plurality of lenticular lenses are stacked on one surface side of the liquid crystal panel 21. The fifth embodiment differs from the above-described embodiments in that an image generator 20E of the fifth embodiment includes a plurality of lenticular lenses between which the liquid crystal panel 21 is disposed.

### 5-2. Constitution

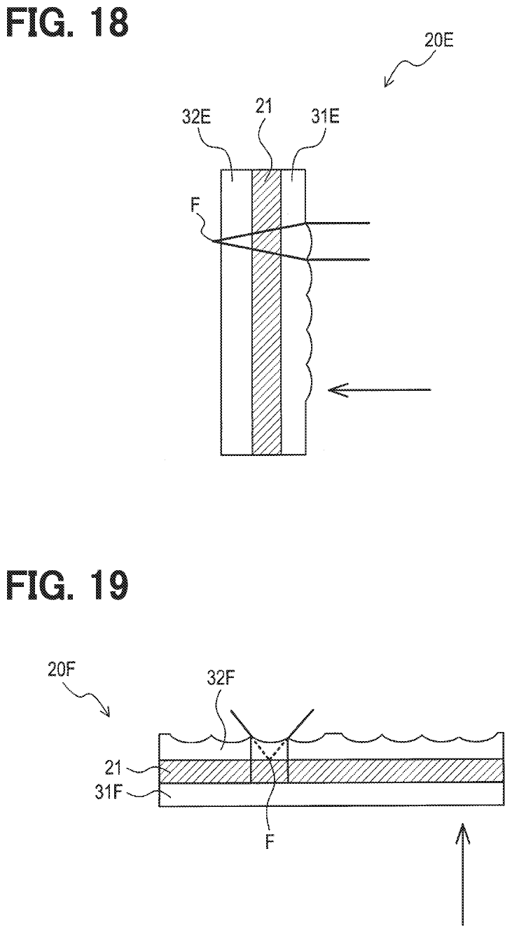

In the head-up display 5 of the fifth embodiment, the three-dimensional display device 10 includes the image generator 20E as shown in FIGS. 17 and 18. The image generator 20E includes a pixel lenticular 31E and a sub-pixel lenticular 32E in addition to the liquid crystal panel 21 described above.

The pixel lenticular 31E is disposed so as to be in contact with one surface of the liquid crystal panel 21, the one surface facing toward the light source 11. The horizontal diffusion plate 26 and the sub-pixel lenticular 32E are disposed so as to be in contact with another surface of the liquid crystal panel 21, the another surface facing toward the lenticular 16 for three-dimensional vision and the projection lens 17. Specifically, the lenticular lenses 31E and 32E are directly joined to the liquid crystal panel 21, and thus, the spacer 41 is not required. Each of the pixel lenticular 31E and the sub-pixel lenticular 32E is convex lenses and is configured as a lenticular lens. The focal point positions F by the pixel lenticular 31D and the sub-pixel lenticular 32D thus held are set to be closer to the lenticular 16 for three-dimensional vision than the sub-pixel lenticular 32D is.

### 5-3. Technical Effect

The fifth embodiment specifically described in the above provides the technical effect (1a) of the above-described first embodiment and further provides the following technical effects.

(5a) In the head-up display 5 described above, the liquid crystal panel 21 is configured to transmit the light from the light source, and the pixel lenticular 31E is disposed on one side of the liquid crystal panel 21, the one side facing toward the light source 11. The sub-pixel lenticular 32E is disposed on another side of the liquid crystal panel 21, the another side facing toward the lenticular 16 for three-dimensional vision and the projection lens 17.

In this head-up display 5, it is unnecessary to ensure an interval between the pixel lenticular 31E and the sub-pixel lenticular 32E, and therefore, it is unnecessary to dispose the spacer 41 for ensuring the interval.

### 6. Sixth Embodiment

### 6-1. Difference from Fifth Embodiment

In the fifth embodiment described above having the configuration in which the liquid crystal panel 21 is disposed between the plurality of lenticular lenses, the image generating unit 20E including the plurality of lenticular lenses having the convex lenses is provided. The sixth embodiment is different from the fifth embodiment in that the sixth embodiment is provided with an image generator 20F including a plurality of lenticular lenses having concave lenses and convex lenses.

### 6-2. Configuration

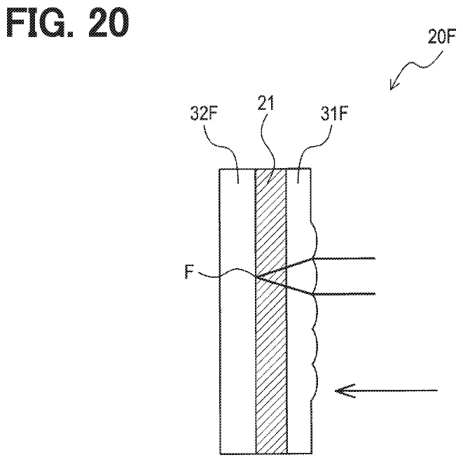

In the head-up display 6 of the sixth embodiment, the three-dimensional display device 10 includes the image generator 20F as shown in FIGS. 19 and 20. The image generator 20F includes a pixel lenticular 31F and a sub-pixel lenticular 32F in addition to the liquid crystal panel 21 described above.

The pixel lenticular 31F is arranged between the light source 11 and the liquid crystal panel 21 so as to be in contact with the liquid crystal panel 21 and is configured as convex lenses. The sub-pixel lenticular 32E is arranged between the liquid crystal panel 21 and the lenticular 16 for three-dimensional vision so as to be in contact with the liquid crystal panel 21, and is configured as concave lenses.

The focal point positions F by the pixel lenticular 31F and the sub-pixel lenticular 32F are on a surface of the liquid crystal panel 21.

### 6-3. Technical Effect

The sixth embodiment specifically described in the above provides the technical effect (1a) of the above-described first embodiment, and further provides the following technical effects.

(6a) The head-up display 6 of the sixth embodiment is configured such that the focal point positions F by the pixel lenticular 31F and the sub-pixel lenticular 32F are on the surface of the liquid crystal panel 21.

In this head-up display 6 having a configuration using a plurality of lenticular lenses, the focal point positions F of the lenticular lenses are set on the surface of the liquid crystal panel 21 and therefore an influence of the light diffraction at the opening portion of the liquid crystal panel 21 is suppressible.

### 7. Other Embodiments

Although embodiments of this present disclosure have been illustrated above, the present disclosure is not limited to the above-illustrated embodiments, and various modifications are possible.

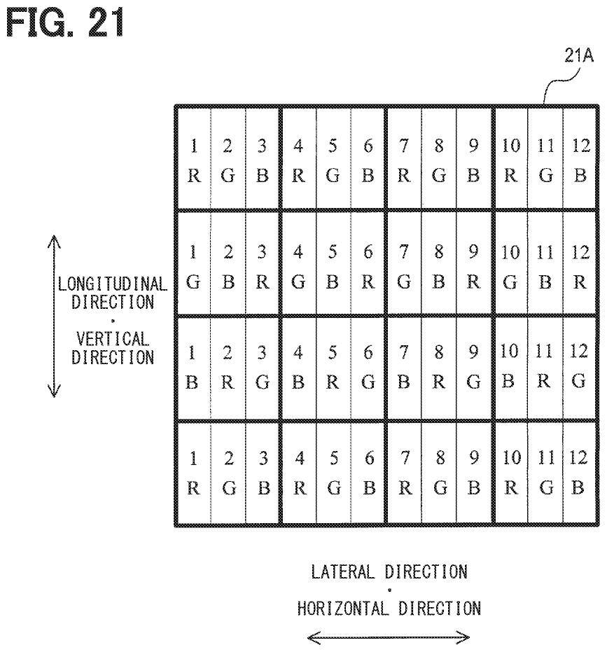

(7a) The above embodiments use the liquid crystal panel 21 in which the color generators 21R, 21G, 21B are arranged as shown in FIG. 3, but this is not limiting. For example, a liquid crystal panel 21A as shown in FIG. 21 may be used.

In the liquid crystal panel 21A, when the color generators 21R, 21G, 21B at the uppermost row are arranged in an order of R, G, B, R, G, and B from the left, the color generators 21R, 21G, 21B at the second uppermost row are arranged in an order of G, B, R, G, B, and R. Further, in the next lower row, the color generators 21R, 21G, 21B are arranged in an order of B, R, G, B, R, and G.

In this configuration, the color generators 21R, 21G, 21B arranged in the longitudinal direction are usable to form a pixel element for a single pixel. Therefore, it is unnecessary to arrange the liquid crystal panel 21A and the lenses 23 and 32 obliquely, and it is possible to match the longitudinal direction and the vertical direction each other and match the lateral direction and the horizontal direction each other. With this configuration, it is possible to improve the use efficiency of the pixels constituting the liquid crystal panel 21A.

When the resolution in the horizontal direction is not took into consideration, the liquid crystal panel 21A and the lenses 23, 32 may have a typical arrangement without having an oblique arrangement, by employing a typical liquid crystal panel in which the color generators 21R, 21G, 21B arranged in the horizontal direction are used to form a pixel element for a single pixel.

(7b) In the above-described embodiments, the liquid crystal panel 21 is employed, and the color generators 21R, 21G, 21B are configured to generate colors by transmitting the backlight. However, this is not limiting. For example, the color generators 21R, 21G, 21B that emit light by themselves such as an organic EL display may be employed. This configuration is applicable to the configurations of the first to fourth embodiments.

(7c) In the first embodiment, the microlenses forming the sub-pixel MLA 23 have the same curvature in the vertical direction and the horizontal direction. However, this is not limiting. For example, the microlenses may be configured as an MLA having different curvatures in the vertical and horizontal directions. When the divergence angle in the horizontal direction is set to that obtained by combining the sub-pixel MLA 23 and the horizontal diffusion plate 26 of the first embodiment, the horizontal diffusion plate 26 may be omitted.

(7d) A plurality of functions of one constituent element in the above embodiments may be realized by a plurality of constituent elements or one function of one constituent element may be realized by a plurality of constituent elements. Further, a plurality of functions realized by a plurality of constituent elements may be realized by one constituent element, or one function realized by a plurality of constituent elements may be realized by one constituent element. Moreover, configurations of the embodiments may be in part omitted. Further, at least a part of the configuration of the above embodiment may be added to or replaced with the configuration of another embodiment.

(7c) In addition to the head-up displays 1 to 6 described above, the present disclosure can be embodied as various systems such as a system including the head-up displays 1 to 6 as its component, an image generation method for generating parallax images using one or more of color-generating refractors, and the like.

### 8. Correspondences Between Configurations of Embodiments and Configurations of the Present Disclosure

In the above embodiments, the light source 11 and the illumination lens 12 correspond to a light provider of the present disclosure. The liquid crystal panel 21 corresponds to an image display of the present disclosure. The sub-pixel MLA 23, the horizontal diffusion plate 26, the sub-pixel lenticular 32B, 32C, 32D, 32E, 32F, and the pixel lenticular 31B, 31C, 31D, 31E, 31F correspond to a color-generating refractor of the present disclosure. The lenticular 16 for three-dimensional vision and the projection lens 17 correspond to a viewpoint refractor of the present disclosure. The sub-pixel MLA 23 and the pixel lenticular 31B, 31C, 31D, 31E, 31F correspond to a first refractor of the present disclosure.

In addition, the horizontal diffusion plate 26 and the sub-pixel lenticular 32B, 32C, 32D, 32E, 32F correspond to a second refractor of the present disclosure. The pixel lenticular 31B, 31C, 31D, 31E, 31F corresponds to a longitudinal lenticular lens of the present disclosure. The sub-pixel lenticular 32B, 32C, 32D, 32E, 32F corresponds to a lateral lenticular lens of the present disclosure. The sub-pixel MLA 23 corresponds to a microlens array of the present disclosure.

What is claimed is:

1. A three-dimensional display device used for a head-up display, comprising:
an image display configured to use a plurality of color generators arranged in a longitudinal direction and a lateral direction to display a plurality of parallax images, two or more of the color generators acting as a pixel element for a single pixel;
one or more color-generating refractors configured to, while transmitting light emitted via the plurality of color generators, converge or diverge the light for each of the color generators, wherein the light is converged or diverged at a preset angle; and
a viewpoint refractor configured to, while transmitting the light transmitted through the color-generating refractor, refract the light toward respective viewpoints,
wherein the color-generating refractor includes:
a first refractor configured to refract the light in at least one of a vertical direction or a horizontal direction; and
a second refractor configured to refract the light in the horizontal direction only.

2. The three-dimensional display device according to claim 1, wherein:
the first refractor includes
a longitudinal lenticular lens in which hemi-cylindrical lenses each having a width matching an arrangement pitch of the color generators in the longitudinal direction are arranged in the vertical direction; and
the second refractor includes
a lateral lenticular lens in which hemi-cylindrical lenses each having a width matching an arrangement pitch of the color generators in the lateral direction are arranged in the horizontal direction.

3. The three-dimensional display device according to claim 1, wherein:
the image display is configured to transmit light from a light source;
the first refractor is disposed between the light source and the image display; and
the second refractor is disposed between the image display and the viewpoint refractor.

4. The three-dimensional display device according to claim 1, wherein
the first refractor and the second refractor are disposed in a stack manner between the viewpoint refractor and the image display.

5. The three-dimensional display device according to claim 1, wherein
the first refractor includes a microlens array in which microlenses configured to cause the light from corresponding respective color generators to be refracted are arrayed; and
the second refractor includes a horizontal diffusion plate configured to diffuse, only in the horizontal direction, the light transmitted through the microlens array.

6. The three-dimensional display device according to claim 1, further comprising:
a pin-hole array plate having a number of holes for the light converged by the first refractor to pass through, wherein the pin-hole array plate is disposed on a side of the first refractor, the side facing toward focal point positions of the first refractor.

7. The three-dimensional display device according to claim 1, wherein
the three-dimensional display device is configured such that:
focal point positions by the first refractor and the second refractor are located on a same plane perpendicular to an optical axis of the first refractor and the second refractor.

8. The three-dimensional display device according to claim 1, further comprising:
a light provider configured to provide parallel light to the plurality of color generators.
